(19) United States
(12) Patent Application Publication
(10) Pub. No.: US 2008/0115811 A1
(43) Pub. Date: May 22, 2008

(54) DISHWASHER APPARATUS INCLUDING A FAN FOR A DRYING CYCLE

(75) Inventors: Gregory Earl Gault, Greenville, NC (US); Torkel Kristensson, Zirndorf (DE); Daniel Melvin Stewart, Kinston, NC (US); David Eugene House, Greenville, NC (US)

Correspondence Address: PEARNE & GORDON LLP, 1801 EAST 9TH STREET, SUITE 1200, CLEVELAND, OH, 44114-3108, US

(73) Assignee: Electrolux Home Products, Inc., Cleveland, OH (US)

(21) Appl. No.: 11/847,828

(22) Filed: Aug. 30, 2007

Related U.S. Application Data
(63) Continuation of application No. 11/561,351, filed on Nov. 17, 2006, now abandoned.

(51) Int. Cl. B08B 3/04

(52) U.S. Cl. 134/95.2

(57) ABSTRACT

A dishwasher apparatus is provided with a housing including an interior area configured to receive dishware. The housing further includes a door configured to provide selective access into the interior area. The dishwasher apparatus further includes a fan configured to encourage air flow through a portion of the interior area during a drying cycle.

### FIELD OF THE INVENTION

The present invention relates generally to dishwasher apparatus, and more particularly, to dishwashing apparatus including a fan for a drying cycle.

### BACKGROUND OF THE INVENTION

Conventional dishwashers typically include dishwasher racks adapted to support articles during a dishwashing cycle. For example, conventional racks may support dishware such as pots, pans, plates, bowls, utensils, glassware, drinking vessels (e.g., cups, mugs, glasses, stemware) or other kitchenware. The racks are convenient to support such dishware throughout the wash, rinse and drying cycles of the dishwasher.

In order to facilitate the drying cycle, known dishwashers frequently include a vent at the top or bottom of the dishwasher door to facilitate evacuation of vapor from the dishwasher interior. There is a continuing need for dishwashers configured to facilitate the drying cycle during operation of the dishwasher.

### BRIEF SUMMARY OF THE INVENTION

Accordingly, it is an aspect of the present invention to provide dishwasher apparatus configured to facilitate the drying cycle of the dishwasher.

To achieve the foregoing and other aspects and in accordance with the present invention a dishwasher apparatus is provided with a housing including a top side wall, a rear side wall, a right side wall and a left side wall at least partially defining an interior area configured to receive dishware. The housing further includes a door configured to provide selective access into the interior area. The housing also includes a first opening configured to provide fluid communication between the interior area and an area outside of the interior area and at a location proximate a bottom of the interior area. The housing still further includes a second opening extending through at least one of the walls and configured to provide fluid communication between the interior area and an area outside of the interior area. The dishwasher apparatus further includes a fan configured to encourage air flow through a portion of the interior area from one of the openings to the other of the openings during a drying cycle.

To achieve further aspects and in accordance with the present invention, a dishwasher apparatus comprises a housing with an interior area configured to receive dishware. The housing further includes a door configured to provide selective access into the interior area. The housing also includes an opening configured to provide fluid communication between the interior area and an area outside of the interior area. The housing further includes a fluid inlet, wherein the dishwasher apparatus is configured to introduce water into the interior area through the fluid inlet during a filling cycle. The dishwasher apparatus further includes a fan configured to encourage air flow through the opening, through a portion of the interior area, and through the fluid inlet to evacuate vapor from the interior area during a drying cycle.

To achieve still further aspects and in accordance with the present invention, a dishwasher apparatus comprises a housing including a top side wall, a rear side wall, a right side wall and a left side wall at least partially defining an interior area configured to receive dishware. The housing further includes a door configured to provide selective access into the interior area. The housing also includes an opening configured to provide fluid communication between the interior area and an area outside of the interior area. The housing still further includes a fluid inlet, wherein the dishwasher apparatus is configured to introduce water into the interior area through the fluid inlet during a filling cycle. The dishwasher apparatus further includes a water bottle positioned outside the interior area, wherein the fluid inlet is configured to provide fluid communication between an interior area of the water bottle and the interior area of the housing. The dishwasher apparatus further includes a water conduit configured to introduce water into the water bottle for subsequent passage through the water inlet and into the interior area during a filling cycle. The dishwasher apparatus also includes an air conduit including a first end in fluid communication with the water bottle and a second end configured to disburse air outside of the interior area during a drying cycle. In addition, the dishwasher apparatus includes a fan configured to encourage air flow through the opening, through a portion of the interior area, through the fluid inlet and through the air conduit to evacuate vapor from the interior area during the drying cycle.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a front view of portions of an example dishwasher apparatus wherein the front door has been removed to reveal the interior area of the housing;

FIG. 2 is a left side view of the dishwasher apparatus of FIG.

FIG. 3 is a top view of the dishwasher apparatus of FIG. 1;

FIG. 4 is a partial sectional view of the dishwasher apparatus along line 4-4 of FIG. 3;

FIG. 5 is a schematic view of portions of another example dishwasher apparatus in accordance with aspects of the present invention; and

FIG. 6 is a sectional view of the dishwasher apparatus of FIG. 5 along line 6-6 of FIG. 5.

### DESCRIPTION OF EXAMPLE EMBODIMENTS

Example embodiments that incorporate one or more aspects of the present invention are described an illustrated in the drawings. These illustrated examples are not intended to be a limitation on the present invention. For example, one or more aspects of the present invention can be utilized in other embodiments and even other types of devices.

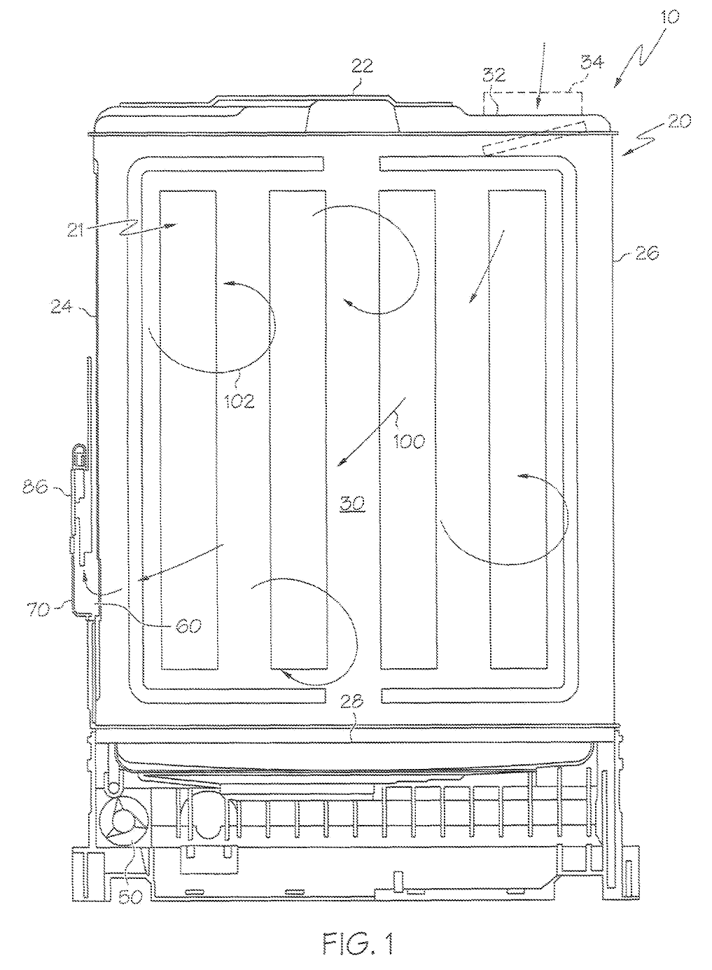

Turning to the shown example of FIG. 1, portions of a dishwasher apparatus 10 is illustrated with the dishwasher door removed to reveal the interior area 21 of a dishwasher housing 20. The housing 20 is configured to receive dishware. For example, it is contemplated that one more conventional racks may be provided to support dishware such as pots, pans, plates, bowls, utensils, glassware, drinking vessels (e.g., cups, mugs, glasses, stemware) or other kitchenware. The racks are convenient to support such dishware throughout the wash, rinse and drying cycles of the dishwasher.

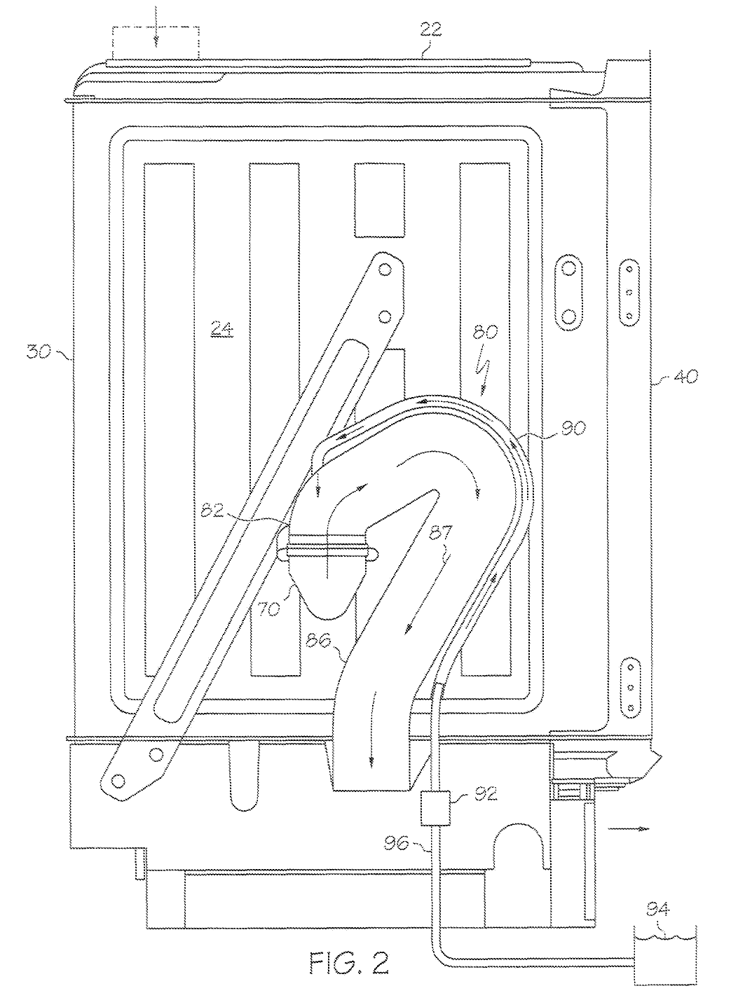

As shown in FIG. 2, the dishwasher apparatus 10 can further include a door 40 configured to provide selective access into the interior area 21. A wide variety of doors may be used in accordance with aspects of the present invention. For instance, the illustrated door 40 can be provided that provides access through the front of the housing 20 into the interior area 21 of the dishwasher apparatus 10.

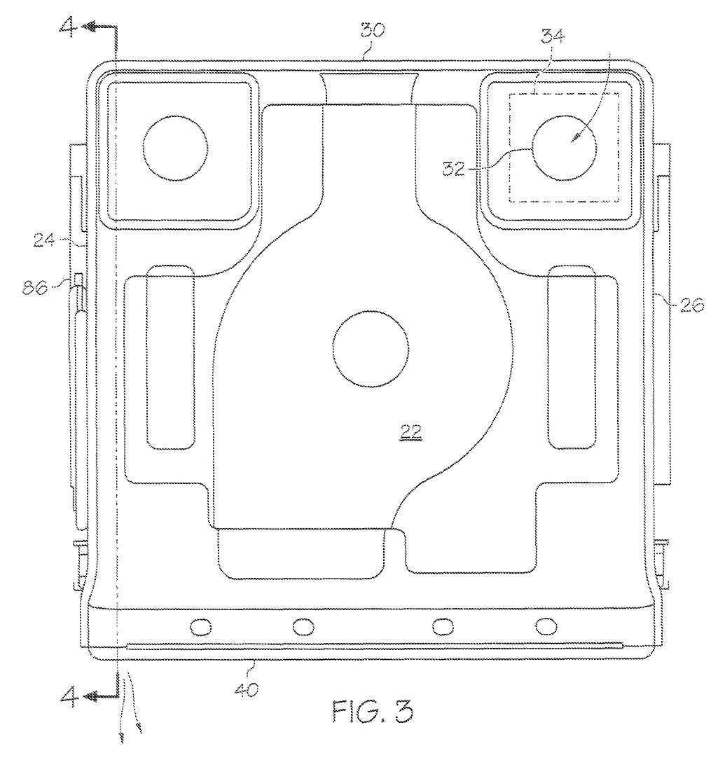

The housing 20 can include a top side wall 22, a left side wall 24, a right side wall 26, a bottom side wall 28 and a rear side wall 30 although other configurations are contemplated in further examples. As shown in FIGS. 1-3, in one example the top side wall 22 can include an opening 32 although such opening may be provided in one or more of the other side walls in further examples. If provided in the top side wall 22, the opening 32 can be located in the rear right side of the top side wall, as shown in FIG. 3, to encourage a cross air flow 100 between the opening 32 and a fluid inlet 60 and may also encourage turbulent air flow and/or eddying air currents 102 that will enhance drying of dishware during the drying cycle.

The opening 32 can be configured to provide fluid communication between the interior area 21 and an area outside of the interior area 21. A flap arrangement that may be configured as a check valve and/or may include an arrangement with a motor configured to actuate the flap to provide selective air passage through the opening 32. In one example, the opening 32 may be provided with a fan assembly 34 shown in broken lines. Such fan assembly 34, if provided, can also provide a flap arrangement that can be actuated in order to permit selective fluid passage through the opening 32. Examples of the present invention may be provided without the fan assembly 34 in order to reduce costs. However, in further applications, providing a fan may be desirable to enhance air flow through the interior area 21 of the housing 20 during the drying cycle of the dishwasher apparatus 10. The fan assembly 34, if provided, can take the form of a wide range of fans, such as blowers. In one example, a muffin-style propeller fan may be used. In further examples, a squirrel-cage-type fan can be used. In still further examples, the intake fan and flapper door illustrated and described in U.S. Patent Application Publication No. 2006/0231122, published Oct. 19, 2006 may be used, the entire disclosure which is hereby incorporated herein in its entirety.

Although not required in all embodiments, the dishwasher apparatus 10 can further include a fluid inlet 60. The dishwasher apparatus 10 is configured to introduce water into the interior area 21 through the fluid inlet 60 during a filling cycle of the dishwasher apparatus 10. The fluid inlet 60 can be configured to allow passage of air and vapors as well as water. For example, the illustrated fluid inlet 60 functions as both an inlet port to add water during a filling cycle and a vent opening to assist in evacuating vapor from the interior area during a drying cycle of the dishwasher apparatus.

In further examples, the dishwasher apparatus 10 can include a water bottle 70 that may be located outside the interior area 21 as shown. The fluid inlet 60 is configured to provide fluid communication between an interior area of the water bottle 70 and the interior area 21 of the housing 20. As shown in FIG. 2, a water conduit 90 can be positioned to add water to the water bottle 70 during the filling cycle. The water conduit 90 can be connected to a water source 94, such as tap water, by way of a water line 96. A valve 92, such as a solenoid valve, may be placed along the water line 96 to allow a microprocessor to open and close the valve 92 as the dishwasher progresses through the various cycles of the dishwashing process.

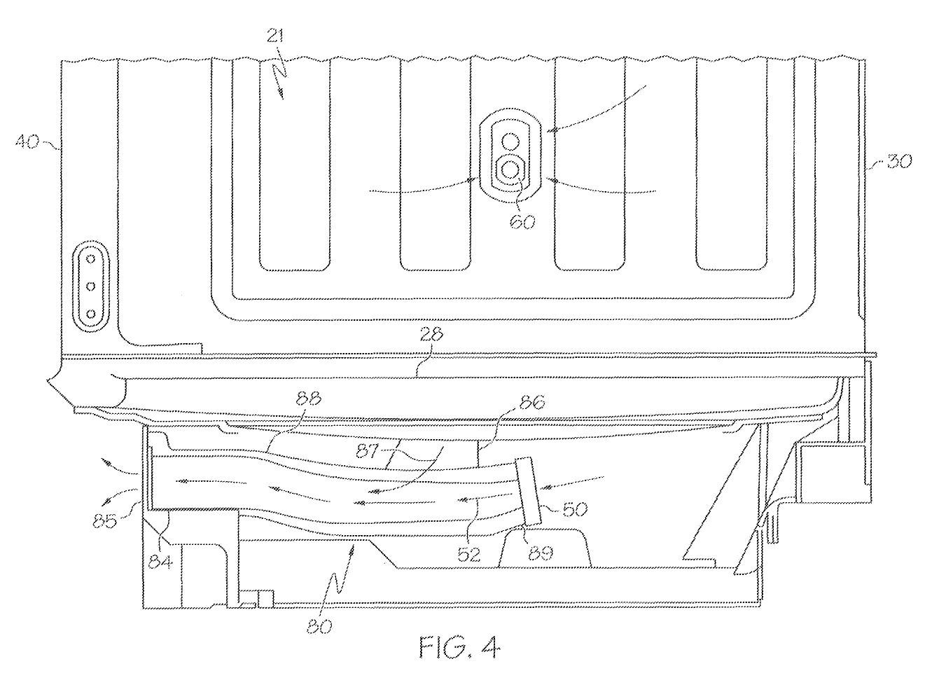

The dishwasher apparatus 10 can further include an air conduit 80 including a first end 82 in fluid communication with the water bottle 70 and a second end 84 (see FIG. 4) configured to disburse air outside of the interior area 21 during the drying cycle. In one example, as shown, the air conduit 80 can include a first inverted substantially J-shaped segment 86 providing a J-shaped vapor path 87 from the fluid inlet 60 during the drying cycle. As shown in FIG. 4, the air conduit 80 can also include a second segment 88 in fluid communication with the inverted substantially J-shaped segment 86, wherein the second segment 88 includes the second end 84 of the air conduit 80. As further illustrated in FIG. 4, the second segment 88 can be positioned at an elevation below the interior area 21 of the housing 20 with the second end 84 of the air conduit being configured to disburse air outside of the interior area 21 at a bottom of the door 40. As shown, an optional grill 85 may be provided to diffuse the air stream as it passes through the second end 84.

The dishwasher apparatus 10 can further include one or more fans configured to encourage air flow through the opening 32 and through the fluid inlet 60 during the drying cycle. As described above, the optional fan 34 may be provided. In addition, or alternatively a fan 50 may be included. The fan 34 and/or the fan 50 can be configured to encourage air flow through the opening 32, through a portion of the interior area 21, and through the fluid inlet 60 to evacuate vapor from the interior area 21 during a drying cycle. As shown the fan 50 and/or the fan 34 can be configured to encourage air flow through the portion of the interior area 21 in a direction from the opening 32 to the fluid inlet 60 during the drying cycle. Although not shown, it is contemplated that the fan 50 and/or the fan 34 may be alternatively arranged to encourage air flow through the portion of the interior area in a direction from the fluid inlet to the opening in further examples.

As shown, the fan 50 can be arranged to introduce air from outside the interior area 21 into the air conduit 80 at a position between the first and second end 82, 84 of the air conduit 80. For example, as shown in FIG. 4, the fan 50 can be mounted adjacent an inlet 89 of the second segment 88 and is configured to introduce air 52 from outside the interior area 21 through the air inlet 80 to subsequently mix with the vapor 87 introduced into the second segment 88 by the inverted J-shaped segment 86 during the drying cycle.

In operation, the dishwasher apparatus 10 may be activated to initiate the dishwashing process. The valve 92 may open to allow water to travel through the water conduit 90 to be dispensed into the water bottle 70. Water within the water bottle 70 is then drained through the fluid inlet 60 into a lower area of the interior area 21 of the housing. Once a sufficient amount of water is introduced, the sprayers within the interior area act to clean the dishware within the interior area. Loaded water can be drained from the interior area and the water bottle 70 can then be used again to provide rinse water into the interior area. After the rinse cycle is complete, the water within the interior area may be drained and the drying cycle may be initiated. In some examples, a heating element (not shown) may be activated to heat the interior area to encourage evaporation of water from the dishware items. The fan 50 can then be activated to introduce outside dry air 52 into the inlet 89 of the second segment 88. The dry air draws a vapor 87 from the first segment 86, thereby mixing together before venting through the second end 84 of the second segment 88. Due to mixing of the dry and vapor air streams, the diffused air stream is less likely to cause condensation adjacent areas adjacent the dishwasher apparatus. Moreover, as air is drawn through the inverted substantially inverted substantially J-shaped segment 86, any condensation may tend to immediately form near the first end 82 and drain back into the water bottle, through the fluid inlet 60 and back into the interior area of the dishwasher apparatus. The fan 50 not only mixes the dry air and vapor air streams but also tends to draw the vapor stream through the air conduit to evacuate vapor from the interior area of the dishwasher apparatus. Fresh, dry air is then introduced by way of the opening 32 to reduce the time necessary to dry the dishware items located within the interior area of the dishwasher apparatus. Although not required, the fan 34 may be provided adjacent opening 32, in addition, or in alternative to the fan 50 to provide an alternative fan location and/or to increase air flow. Moreover, use of two fans may reduce the size required for each fan to produce the desired air circulation.

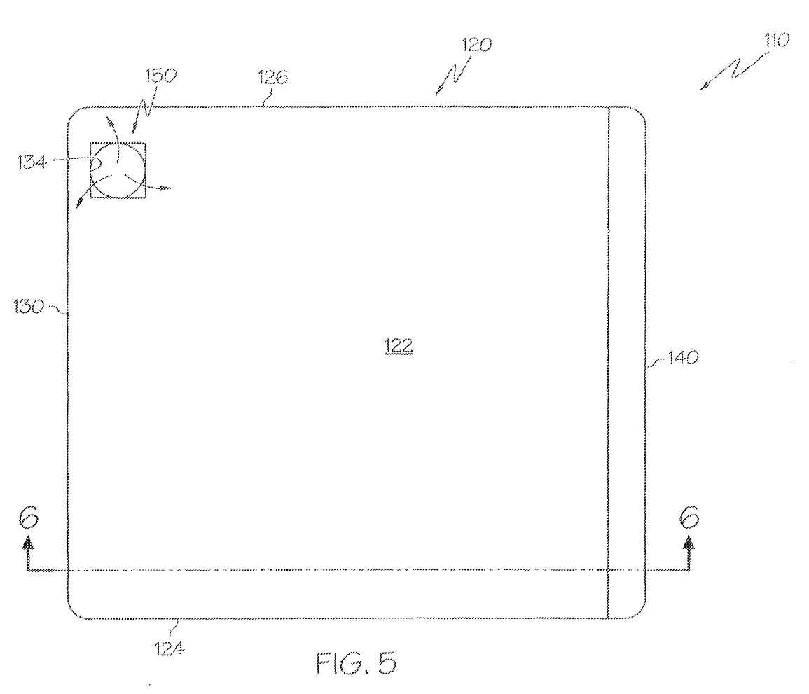

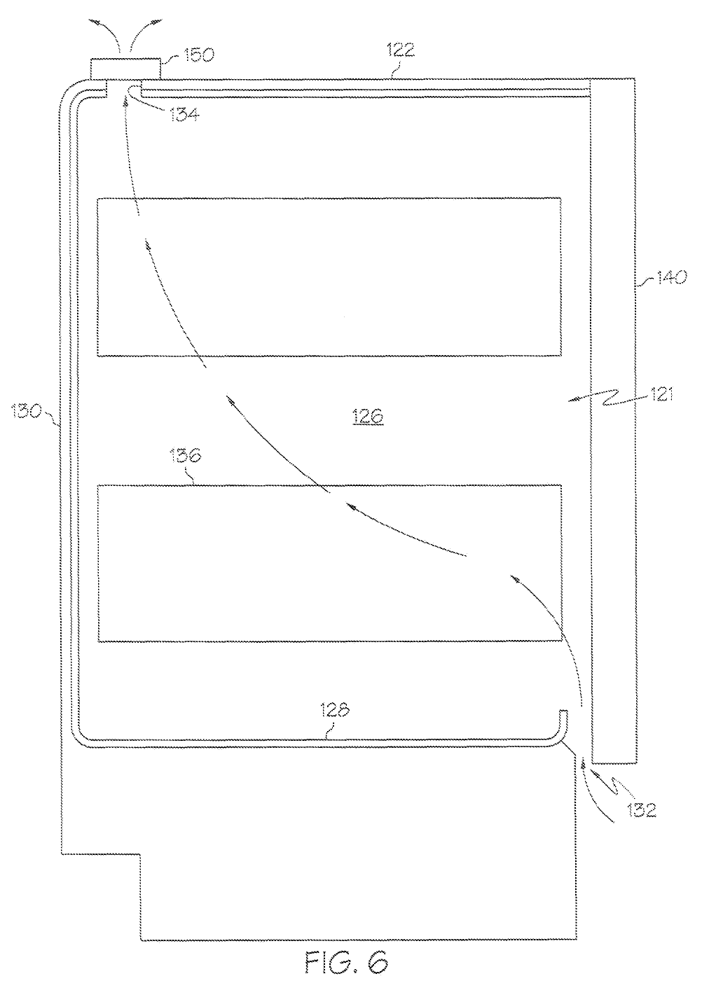

FIGS. 5 and 6 illustrate an alternative dishwasher apparatus 110. As shown, the dishwasher apparatus 110 includes a housing 120 including a top side wall 122, a bottom side wall 128, a rear side wall 130, a right side wall 126 and a left side wall 124 at least partially defining an interior area 121 with racks 136 configured to receive dishware. A door 140 is configured to provide selective access into the interior area 121. The dishwasher apparatus includes a first opening 132 configured to provide fluid communication between the interior area 126 and an area outside of the interior area and at a location proximate a bottom of the interior area 121. As shown, the first opening 132 is located at a bottom of the door 140. For example, the opening 132 can be provided separate from the door or by a space between the door and further portions of the dishwasher apparatus. In one example, the first opening 132 can be provided with structure and at a bottom of the interior area as shown and described in U.S. Patent Application Publication No. 2006/0231122, published Oct. 19, 2006, previously incorporated by reference in its entirety.

The dishwasher apparatus 110 further includes a second opening 134 extending through at least one of the walls and configured to provide fluid communication between the interior area 121 and an area outside of the interior area. Although the second opening 134 can be located in any one of the walls, the illustrated second opening 134 can extend through a rear right portion of the top side wall 122 as shown in FIGS. 5 and 6. In further examples, the second opening can be located to extend through one or more of the top side wall 122, the left side wall 124, the right side wall 126, the bottom side wall 128, and/or the rear side wall 130. Moreover, although a single second opening 134 is illustrated, it is contemplated that the second opening may comprise a plurality of second openings located in the same or different wall.

The dishwasher apparatus 110 further includes a fan 150 configured to encourage air flow through a portion of the interior area 121 from one of the openings 132, 134 to the other of the openings 132, 134 during a drying cycle. For instance, as shown, the fan 150 can be configured to encourage air flow through a portion of the interior area 121 from the first opening 132 to the second opening 134. Although not shown, it is also contemplated that the fan 150 may be arranged to encourage air flow through a portion of the interior area 121 from the second opening 134 to the first opening 132. The fan can be located adjacent the first or second opening. For example, as shown, the fan 150 can be mounted adjacent the second opening 134. The fan 150 can take the form of a wide range of fans, such as blowers. In one example, a muffin-style propeller fan may be used. In further examples, a squirrel-cage-type fan can be used. In still further examples, the intake fan and flapper door illustrated and described in U.S. Patent Application Publication No. 2006/0231122, published Oct. 19, 2006 may be used, previously incorporated by reference in its entirety.

In operation, during the drying cycle, the fan 150 may be activated to draw air from the first opening 132 to the second opening 134 to create a cross draft to enhance drying action of the dishware items in the racks 136. In further examples, the fan can blow air into the second opening 134 to cause air to exit through the first opening 132.

The invention has been described with reference to the example embodiments described above. Modifications and alterations will occur to others upon a reading and understanding of this specification. For example, while the opening 32 and fluid inlet 60 are illustrated in the top side wall 22 and left side wall 24, respectively, it is understood that the opening 32 and fluid inlet 60 may be located in a wide variety of different locations within the housing. Examples embodiments incorporating one or more aspects of the invention are intended to include all such modifications and alterations insofar as they come within the scope of the appended claims.

What is claimed is:

1. A dishwasher apparatus comprising:
a housing including a top side wall, a rear side wall, a right side wall and a left side wall at least partially defining an interior area configured to receive dishware, a door configured to provide selective access into the interior area, a first opening configured to provide fluid communication between the interior area and an area outside of the interior area and at a location proximate a bottom of the interior area, a second opening extending through at least one of the walls and configured to provide fluid communication between the interior area and an area outside of the interior area; and
a fan configured to encourage air flow through a portion of the interior area from one of the openings to the other of the openings during a drying cycle.

2. The dishwasher apparatus of claim 1, wherein the fan is configured to encourage air flow through the portion of the interior area from the first opening to the second opening.

3. The dishwasher apparatus of claim 1, wherein the fan is mounted adjacent the second opening.

4. The dishwasher apparatus of claim 1, wherein the first opening is located at a bottom of the door.

5. A dishwasher apparatus comprising:
a housing including an interior area configured to receive dishware, a door configured to provide selective access into the interior area, an opening configured to provide fluid communication between the interior area and an area outside of the interior area, and a fluid inlet, wherein the dishwasher apparatus is configured to introduce water into the interior area through the fluid inlet during a filling cycle; and
a fan configured to encourage air flow through the opening, through a portion of the interior area, and through the fluid inlet to evacuate vapor from the interior area during a drying cycle.

6. The dishwasher apparatus of claim 5, wherein the fan is configured to encourage air flow through the portion of the interior area in a direction from the opening to the fluid inlet during the drying cycle.

7. The dishwasher apparatus of claim 5, further comprising a water bottle, wherein the fluid inlet is configured to provide fluid communication between an interior area of the water bottle and the interior area of the housing.

8. The dishwasher apparatus of claim 7, further comprising a water conduit configured to introduce water into the water bottle for subsequent passage through the water inlet during the filling cycle.

9. The dishwasher apparatus of claim 7, further comprising an air conduit including a first end in fluid communication with the water bottle and a second end configured to disburse air outside of the interior area during the drying cycle.

10. The dishwasher apparatus of claim 9, wherein the second end of the air conduit is configured to disburse air outside of the interior area at a bottom of the door.

11. The dishwasher apparatus of claim 9, wherein the fan is configured to introduce air from outside the interior area into the air conduit at a position between the first and second end of the air conduit.

12. The dishwasher apparatus of claim 9, wherein the air conduit includes a first inverted substantially J-shaped segment including the first end of the air conduit.

13. The dishwasher apparatus of claim 12, wherein the air conduit includes a second segment in fluid communication with the inverted substantially J-shaped segment, wherein the second segment includes the second end of the air conduit.

14. The dishwasher apparatus of claim 13, wherein the fan is mounted adjacent an inlet of the second segment and is configured to introduce air from outside of the interior area through the air inlet to subsequently mix with vapor introduced into the second segment by the inverted J-shaped segment during the drying cycle.

15. The dishwasher apparatus of claim 13, wherein the second segment is positioned at an elevation below the interior area of the housing.

16. A dishwasher apparatus comprising:
a housing including a top side wall, a rear side wall, a right side wall and a left side wall at least partially defining an interior area configured to receive dishware, a door configured to provide selective access into the interior area, an opening configured to provide fluid communication between the interior area and an area outside of the interior area, and a fluid inlet, wherein the dishwasher apparatus is configured to introduce water into the interior area through the fluid inlet during a filling cycle;
a water bottle positioned outside the interior area, wherein the fluid inlet is configured to provide fluid communication between an interior area of the water bottle and the interior area of the housing;
a water conduit configured to introduce water into the water bottle for subsequent passage through the water inlet and into the interior area during a filling cycle;
an air conduit including a first end in fluid communication with the water bottle and a second end configured to disburse air outside of the interior area during a drying cycle; and
a fan configured to encourage air flow through the opening, through a portion of the interior area, through the fluid inlet and through the air conduit to evacuate vapor from the interior area during the drying cycle.

17. The dishwasher apparatus of claim 16, wherein the fan is configured to introduce air from outside the interior area into the air conduit at a position between the first and second end of the air conduit.

18. The dishwasher apparatus of claim 16, wherein the air conduit includes a a first inverted substantially J-shaped segment including the first end of the air conduit and a second segment in fluid communication with the inverted substantially J-shaped segment, wherein the second segment includes the second end of the air conduit.

19. The dishwasher apparatus of claim 18, wherein the fan is mounted adjacent an inlet of the second segment and is configured to introduce air from outside of the interior area through the air inlet to subsequently mix with vapor introduced into the second segment by the inverted substantially J-shaped segment during the drying cycle.

20. The dishwasher apparatus of claim 18, wherein the second segment is positioned at an elevation below the interior area of the housing.
